(19) United States
(12) Patent Application Publication
(10) Pub. No.: US 2015/0039485 A1
(43) Pub. Date: Feb. 5, 2015

(54) BILLING TRANSACTION CURRENCY NORMALIZATION

(71) Applicant: MetraTech Corp., Waltham, MA (US)

(72) Inventors: Jonah Egenolf, Winchester, MA (US); Robert Parks, Weston, MA (US)

(21) Appl. No.: 13/955,387

(22) Filed: Jul. 31, 2013

(51) Int. Cl. G06Q 20/14; G06Q 40/04

(52) U.S. Cl. CPC G06Q 20/14; G06Q 40/04
USPC 705/37

(57) ABSTRACT

An apparatus and method for processing of transactions that originate in differing currencies is described herein. More particularly, a currency conversion is described that occurs during for the purposes of counting transactions and charges while rate calculations such as the application of a discount occur in the multiple, different underlying currencies. Thus, the converted or standardized currency is used to determine if thresholds are satisfied and not for setting or calculation of charges.

### BACKGROUND

Billing systems can set rates/charges according to an aggregate decision model. In general, an aggregate decision can include any decision that requires the consideration of a set of events to appropriately be evaluated (e.g., as opposed to a decision that can be made based on a single event). Thus, it can be necessary for a billing system to consider multiple transactions when determining the appropriate rate or charge for an account.

### SUMMARY

An apparatus and method for processing of transactions that originate in differing currencies is described herein. More particularly, a currency conversion is described that occurs during for the purposes of counting transactions and charges while rate calculations such as the application of a discount occur in the multiple, different underlying currencies. Thus, the converted or standardized currency is only used to determine if thresholds are satisfied and not for setting or calculation of charges.

In some aspects, a method for processing and messages associated with transactions in a billing system includes receiving a plurality of messages associated with transactions received by the billing system, the messages including transaction information and an account identifier, grouping the transactions into one or more billing groups based on the account identifier, with a billing group including multiple logically connected accounts that cannot be processed separately, for a particular billing group, determining charges based on the received transaction information, the charges including charges incurred in multiple, different currencies, converting the charges incurred in the multiple, different currencies to a standard currency unit, aggregating the charges in the standard currency to generate aggregate charge information in the standard currency unit, comparing the aggregate charge information to a threshold, and upon determining that the aggregate charge information satisfies the threshold applying a discount to the charges for each of the accounts and the billing group in the multiple, different currencies.

Other embodiments of these aspects include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination.

The billing group includes multiple logically connected accounts with each account having an associated currency. Converting the charges to the standard currency unit includes converting the charges for each transaction to the standard currency unit. Converting the charges to the standard currency unit includes summing the charges for each of the multiple different currencies to generate an aggregate charge for each of the multiple different currencies and converting the aggregate charge for each of the multiple different currencies to the standard currency unit. The messages include information about a location where the charge was incurred and the method also includes determining the base currency based on the location where the charge was incurred. The method also includes comparing the aggregate charge information to a notification threshold and upon determining that the aggregate charge information satisfies the notification threshold sending a notification to the account owner associated with the account.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIGS. 1A and 1B provide schematic diagrams of a process for grouping transactions in a billing system.

FIG. 2 is an exemplary schematic diagram of a counting and discount allocation process for transactions originating in multiple, different underlying currencies.

FIG. 3 is an exemplary system for processing transactions originating in multiple, different underlying currencies.

FIG. 4 is a flow chart of a process for processing transactions.

### DETAILED DESCRIPTION

An apparatus and method for handling billing transactions that are based on multiple transactions originating in multiple, different currencies in a billing system is described herein. Information about a particular transaction can be used in aggregate with information about other transactions to calculate a rate, discount, or charge for an account or group of accounts. In many situations, when the billing system processes transactions based on the received messages, the processing relies on aggregate decision models as the processing of any one particular transaction is potentially affected by other transactions. These transactions can span not only time but also location resulting in transactions that affect another account potentially being accrued in a different currency than the subject account. Thus, the billing system is configured to process aggregate decisions that require the consideration of a set of events or transactions to be appropriately evaluated (e.g., in contrast to a decision they can be made by looking at a single transaction). One example of such an aggregate decision can be rates, discounts or charges based on consumer usage such as charges that are generated if a customer accrues too much usage or doesn't meet a minimum commitment level. In another example, a discount can be provided to all accounts having a particular characteristic if certain cost thresholds are met. In yet another example, billing restrictions can be applied to a group of individual accounts such as a family or organization and charges can be based on aggregate charges incurred for the group of accounts.

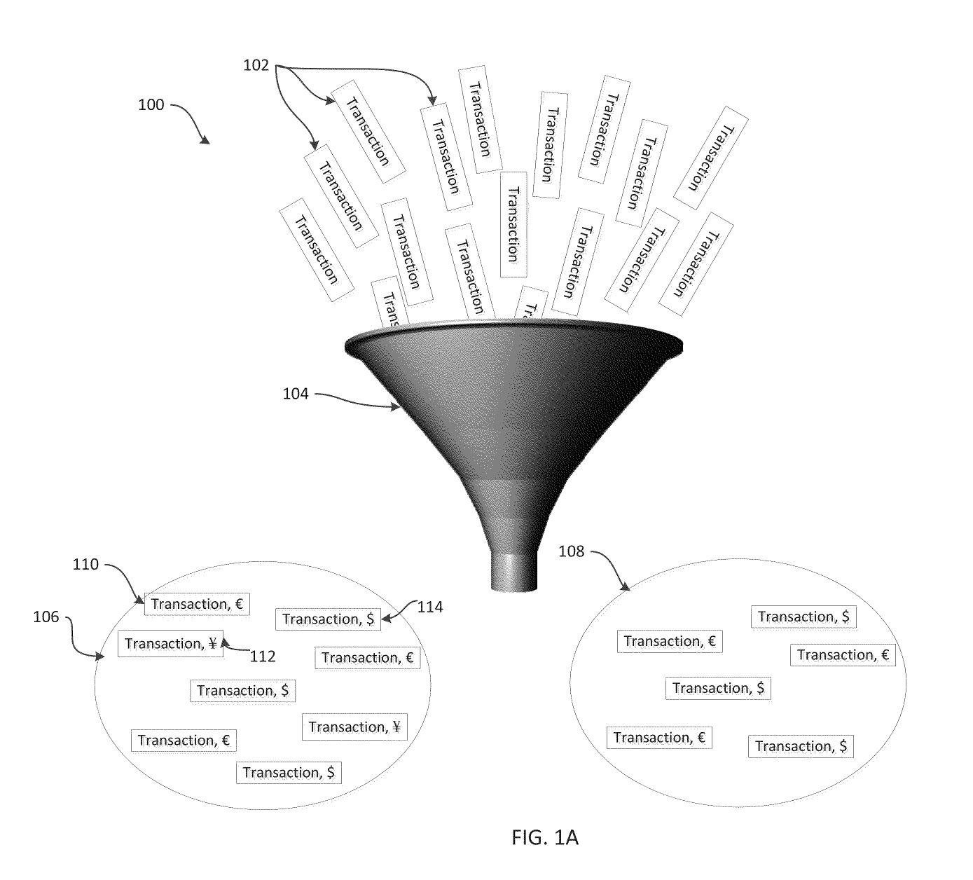

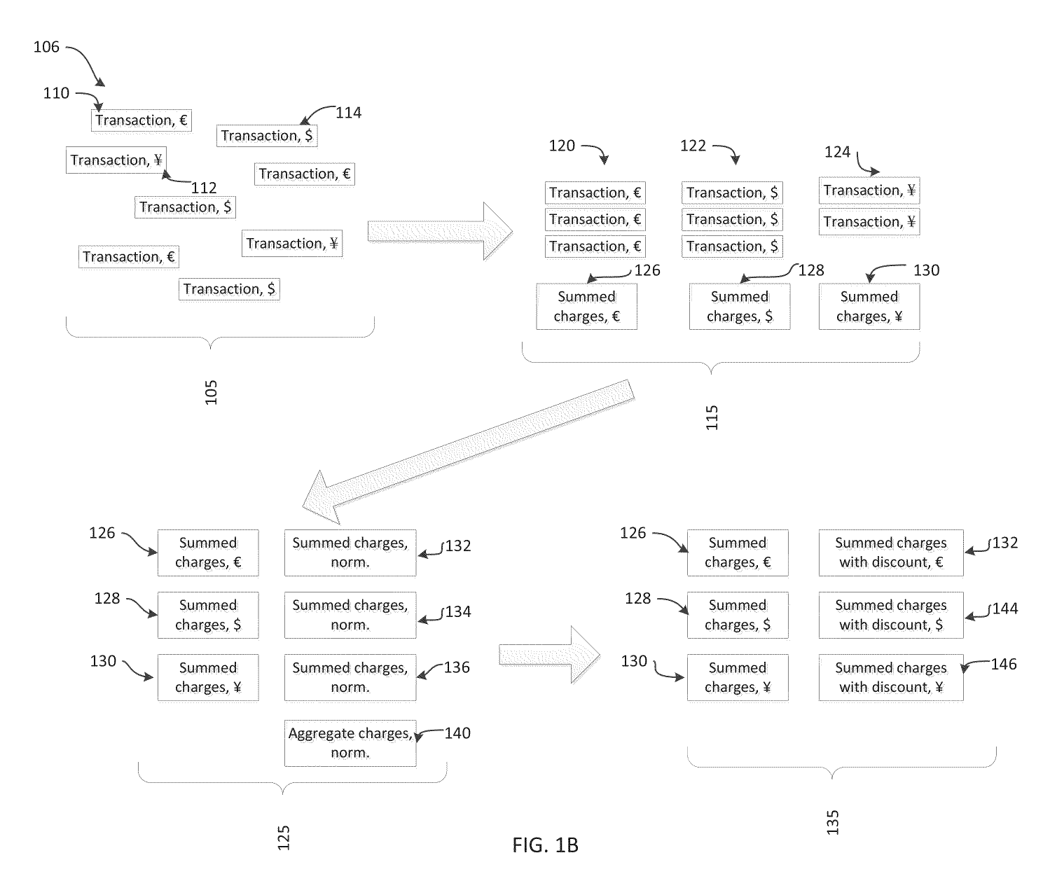

Referring to FIG. 1A, a process for grouping and processing transactions using an aggregate decision model is shown. Accounts can be grouped into billing groups where a set of accounts that are affected by transactions of other accounts in the set of accounts are included in a billing group—e.g., a corporation having places of business in Europe, Japan, Brazil, and the US could have four separate accounts that are grouped for purposes of billing rate determination. As such, the events and transactions for accounts within a billing group may be affected by other transactions for the same or other accounts in the billing group. While the rates are related, the accounts within a billing group may be billed separately in multiple, different underlying currencies based on the location of the account.

In the example of FIG. 1A, two billing groups are shown. Billing for accounts in a particular billing group may be affected by transactions from another account within the billing group. As transactions 102 enter the billing system 100 as messages, the system allocates each of the transactions to a particular billing group for billing purposes. More particularly, each transaction is associated with a particular account within the billing system and the identity of the account can be determined based on account identifying information in the message. A billing group can have transactions originating in multiple different currencies. For example, billing group 106 includes transactions that incur charges in euros (e.g., transaction 110), transactions that incur charges in Yen (e.g., transaction 112), and transactions that incur charges in dollars (e.g., transaction 114).

Referring to FIG. 1B, a process for processing transactions using the aggregate decision model based on the billing group 106 determined using the process shown in FIG. 1A.

As shown in the example of FIG. 1B, a particular billing group 106 (e.g. shown in portion 105) includes transactions in multiple different currencies such as euros (e.g., transaction 110), Yen (e.g., transaction 112), and dollars (e.g., transaction 114). While the accounts within billing group 106 may be billed in the multiple, different underlying currencies other billing functions may be based on an aggregate or total bill for the billing group as a whole. For example, the billing system may be programmed to provide updates to an account manager when the bill for the group as a whole exceeds a predetermined threshold. Such an update can enable the account manager to more effectively manage usage and spending and usage for the accounts. In another example the billing system may provide a discount if the total expenditure for the group of accounts exceeds a threshold. In yet another example, the billing system may charge an additional fee if the billing total expenditure for the group of accounts falls below a particular threshold. Thus, it is important for the billing system to provide information about the total accrued billings for the billing group 106 in order to effectively process other transactions for the billing group 106.

In order to determine the aggregate or total billing expenditure for the group of accounts, the system groups the transactions according to their underlying currencies. In the example shown in portion 115 of FIG. 1B, the transactions occurring in euro are collected into a group 120, the collections occurring in dollars are collected into a group 122 and the collections occurring in yen are grouped into a group 124. The system calculates an aggregate charge for each of the currencies, e.g., aggregate charges 126, 128 and 130. The aggregate charge can be calculated by summing each of the individual transaction charges for the currency. Thus, after aggregation the system stores a summed or total charge for each currency.

In order to take actions that are based on the total spending for the billing group, as shown in portion 125 of FIG. 1B, the system converts the summed charges from the different underlying currencies (e.g., summed charges 126, 128 and 120) into a standard or base currency. For example, all of the summed charges could be converted into a single currency, such as US dollars or Euros using an exchange rate that is accessed by the billing system. After converting all of the summed charges into standardized charges in the base currency, the system calculates an aggregate charge 140 in the base currency. Aggregate charge 140 can be compared to a threshold to determine other actions applied by the system, such as the sending of electronic notifications or the application of a charge or discount.

As shown in portion 135 of FIG. 1B, if the summed charges in the normalized currency 140 exceed a threshold for application of the discount, the application of the discount occurs based on the charges in the underlying currencies. For example, the summed charges 126, 128, and 130 which are in different currencies from one another are each used as the charge for the application of the discount. For example, for charges occurring in yen (e.g., 130), the discount is applied to the summed charges in yen to generate a summed charge with discount 146. By summing the charged in a normalized currency but applying the discounts in the underlying currencies, issues related to exchange rate fluctuation can be mitigated.

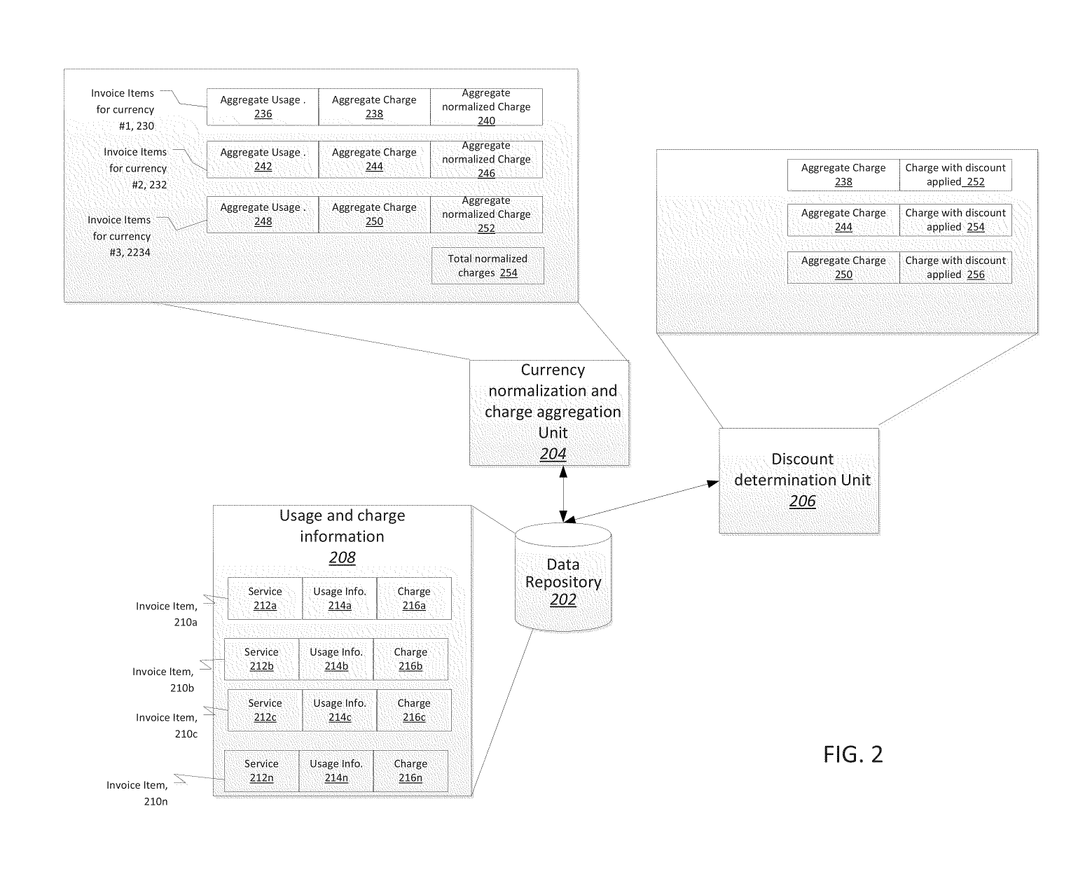

Referring to FIG. 2, network environment is configured to use a currency normalization and charge aggregation unit 204 in combination with a discount determination unit 206 to generate charges for an account. In the example of FIG. 2, data repository 202 stores usage and charge information 208. This usage and charge information 208 includes invoice items 210a . . . 210n, which include information indicative of usage and charges for multiple accounts. Each of the invoice items 210a . . . 210n include information about the type of service used (e.g., entries 212a . . . 212n), the usage information (e.g., entries 214a . . . 214n), and the associated charges (e.g., entries 216a . . . 216n). As noted above, the invoice items 210a . . . 210n can be grouped based on the account or billing group to which the invoice item should be allocated based on an account identifier associated with each invoice item. After grouping of the invoice items 210a . . . 210n, other actions may be performed by the system based on total usage and or charges to the billing group.

The currency normalization and charge aggregation unit 204 accesses the invoice items 210a . . . 210n to determine an aggregate total charge for the billing group in a normalized currency. More particularly, the normalization and charge aggregation unit 204 receives the invoice items 210a . . . 210n for a set of accounts in the billing group and calculates the aggregate usage and charges for the account for each of the base currencies in which the charges were originated. For example, charges can originate in multiple different currencies and the currency normalization and charge aggregation unit 204 generates aggregate usage information (e.g., aggregate usage 236, 242, and 248) and aggregate charge information (e.g., aggregate charge 238, 244, 250) for the invoice items grouped according to the base currency. In the particular example shown in FIG. 2, charges are incurred in three different currencies and the total usage and total charges are calculated (e.g., summed) for each of the different currencies. The currency normalization and charge aggregation unit 204 also converts each of the aggregate charges (e.g., aggregate charge 238, 244, 250) into a normalized aggregate charge (e.g., normalized aggregate charge 240, 246, and 252). Each of the normalized aggregate charges is provided in the same currency. For example, the system accesses a currency conversion rate for each of the base currencies to convert the charge to the normalized currency. Based on the normalized aggregate charges, the currency normalization and charge aggregation unit 204 generates a total aggregate charge for the billing group in a normalized currency. Thus, the invoice items which originated in various different currencies are converted into a standard or base currency and then summed to generate the aggregate normalized charge 254.

The system 200 also includes a discount determination unit 206. The discount determination unit 206 uses information about the aggregate normalized charge 254 in order to determine whether a threshold for application of a discount or assessment of a penalty has been satisfied. For example, if the aggregate normalized charge 254 exceeds a discount application threshold, the discount determination unit 206 applies the discount to the invoice items. In another example, if the aggregate normalized charge value 254 fails to satisfy a penalty threshold, the discount determination unit applies the penalty charge to the invoice items. More particularly, upon determination that a discount or penalty should be assessed to the accounts in the billing group, the discount determination unit 206 accesses the aggregate charge information in each of the base currencies (e.g., aggregate charge 238, 244, 250) and applies the discount or penalty and each of the respective underlying currencies to generate the charge with discount and/or penalty applied (e.g., entries 252, 254, and 256).

Thus, as described above, system 200 calculates the aggregate or total usage for accounts in a billing group in a normalized currency but applies the actual discount or other modification to the total charges in the respective underlying currencies in which the charges originated. This provides the advanctage of lessening the impact of currency fluctuation on the billing process. More particularly, since modifications to the charges occur in the base currency the currency conversion rate has less of an effect on the charges to the accounts. Thus, Full unit/currency conversion occurs during counting—aggregate N currencies/UoMs into 1 currency/UoM for the purposes of counting, rate in another currency/UoM, assign rate back in the underlying N currencies.

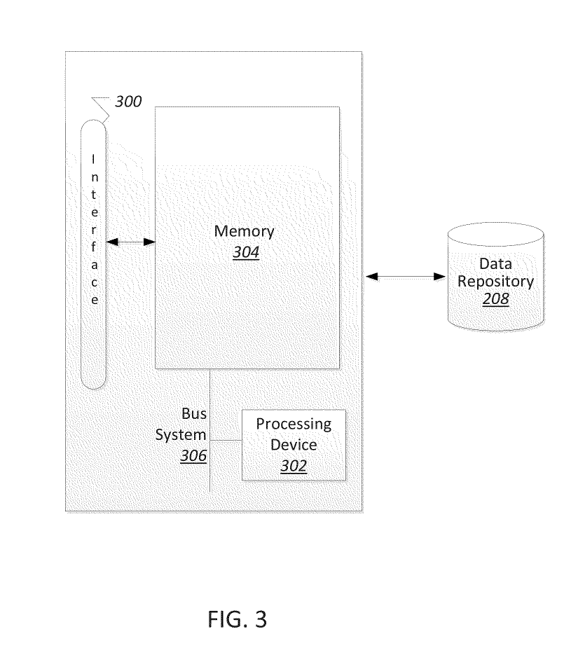

Referring to FIG. 3, the currency normalization and charge aggregation unit 204 and discount determination unit 206 can be implemented using a variety of computing devices capable of receiving data and running one or more services (e.g., a discount determination service). In an example, currency normalization and charge aggregation unit 204 and a discount determination unit 206 can include a server, a distributed computing system, a desktop computer, a laptop, a cell phone, a rack-mounted server, any combination of the foregoing, and the like. The currency normalization and charge aggregation unit 204 and discount determination unit 206 can be implemented as a single server or a group of servers that are at a same position or at different positions. Although distinct modules are shown in the figures, in some examples, client and server programs can run on the same device.

The currency normalization and charge aggregation unit 204 and discount determination unit 206 can receive data from client device through input/output (I/O) interface 300. I/O interface 300 can be a type of interface capable of receiving data over a network, including, e.g., an Ethernet interface, a wireless networking interface, a fiber-optic networking interface, a modem, and so forth. The system also includes a processing device 302 and memory 304. A bus system, 306, including, for example, a data bus and a motherboard, can be used to establish and to control data communication between the components.

Processing device 302 can include one or more microprocessors. Generally, processing device 302 can include an appropriate processor and/or logic that is capable of receiving and storing data, and of communicating over a network. Memory 304 can include a hard drive and a random access memory storage device, including, e.g., a dynamic random access memory, or other types of non-transitory machine-readable storage devices. As shown in FIG. 3, memory 304 stores computer programs (not shown) that are executable by processing device 302. These computer programs may include a data engine (not shown) for implementing the operations and/or the techniques described herein. The data engine can be implemented in software running on a computer device, hardware or a combination of software and hardware.

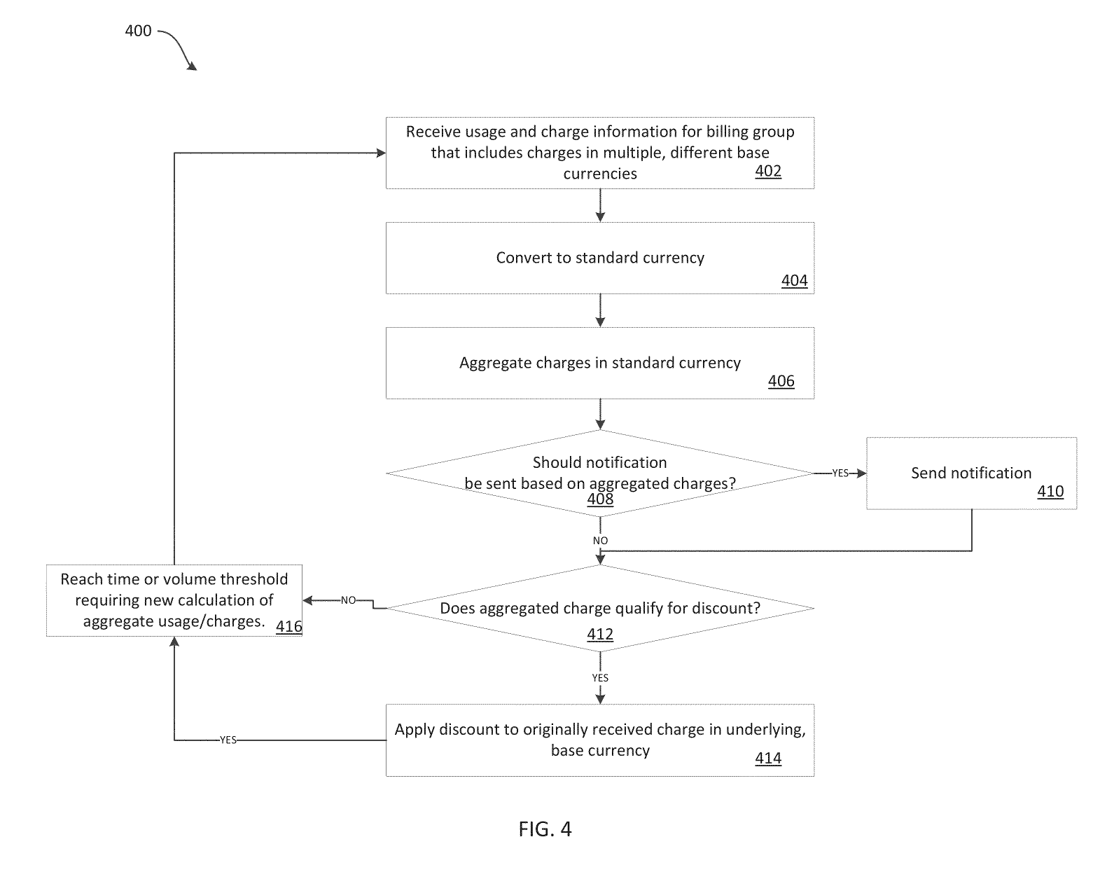

FIG. 4 shows a flow chart of a process 400 for normalizing currency in a billing system prior to making a determination of whether pre-assigned thresholds for billing actions (e.g., discounts, fees, notifications) for a billing group are satisfied. The billing system receives usage and charge information for a billing group (402). The billing group can include multiple accounts, each billed in a different underlying currency but associated with one another for determining rate, discount and/or fees to be applied to the individual accounts. The usage and charge information includes charges in multiple, different base currencies. The system converts the charges to a standard currency base (404). For example, all of the charges can be converted to one particular currency. In some examples, each of the individual charges are converted to the standard currency using a stored conversion rate that is updated daily. In other examples, the charges incurred in particular base currency (e.g., all of the charges for a particular account) are aggregated (e.g., summed) and the aggregated charge is converted to the standardized currency using the stored conversion rate. After the charges have been converted to the standardized currency, the system aggregates the charges in the standard currency (406). For example, the system can calculate a summation of the charges (or aggregated charges) in the normalized currency.

Using the aggregated charges in the standardized currency, the system determines whether notification should be sent based on the total aggregated charges (408). For example, if the total incurred charges exceed a predetermined threshold, the system sends a notification to the account owner(s) of the level of usage/charges incurred for the accounts in the billing group (410). If the total aggregated charges do not exceed a notification threshold and/or the system is not configured to send notifications for the particular billing group, the system determines whether the aggregated charges qualify for a discount (412). For example, the system can compare the total aggregated charges in the standard currency to a threshold value. If the total aggregated charges satisfy the threshold, the system applies a discount to the originally received charge in the underlying, base currency (414). Thus, the standard currency is used to determine whether thresholds for notifications and discounts are satisfied, and the underlying base currencies are used for the application of additional discounts or charges to the accounts in the billing group. Thus, if the aggregated charge does not qualify for a discount or the system has already applied the discount to the underlying charges, the system then wait until a time or volume threshold that requires a new calculation of the aggregate uses and charges is reached (416). When the time or volume threshold has been satisfied, the system returns to receiving the usage and charge information at block 402.

Although a few implementations have been described in detail above, other modifications are possible. In addition, the logic flows depicted in the figures do not require the particular order shown, or sequential order, to achieve desirable results. Other steps may be provided, or steps may be eliminated, from the described flows, and other components may be added to, or removed from, the described systems. Accordingly, other implementations are within the scope of the following claims.

What is claimed is:

1. A method for processing and messages associated with transactions in a billing system, the method comprising:
receiving a plurality of messages associated with transactions received by the billing system, the messages including transaction information and an account identifier;
grouping the transactions into one or more billing groups based on the account identifier, with a billing group including multiple logically connected accounts that cannot be processed separately;
for a particular billing group, determining charges based on the received transaction information, the charges including charges incurred in multiple, different currencies;
converting the charges incurred in the multiple, different currencies to a standard currency unit;
aggregating the charges in the standard currency to generate aggregate charge information in the standard currency unit;
comparing the aggregate charge information to a threshold; and
upon determining that the aggregate charge information satisfies the threshold applying a discount to the charges for each of the accounts and the billing group in the multiple, different currencies.

2. The method of claim 1, wherein the billing group includes multiple logically connected accounts with each account having an associated currency.

3. The method of claim 1, wherein converting the charges to the standard currency unit comprises converting the charges for each transaction to the standard currency unit.

4. The method of claim 1, wherein converting the charges to the standard currency unit comprises:
summing the charges for each of the multiple different currencies to generate an aggregate charge for each of the multiple different currencies;
converting the aggregate charge for each of the multiple different currencies to the standard currency unit.

5. The method of claim 1, wherein the messages include information about a location where the charge was incurred and the method further comprises determining the base currency based on the location where the charge was incurred.

6. The method of claim 1, further comprising:
comparing the aggregate charge information to a notification threshold;
upon determining that the aggregate charge information satisfies the notification threshold sending a notification to the account owner associated with the account.

7. A system configured to:
receive a plurality of messages associated with transactions received by the billing system, the messages including transaction information and an account identifier;
group the transactions into one or more billing groups based on the account identifier, with a billing group including multiple logically connected accounts that cannot be processed separately;
for a particular billing group, determine charges based on the received transaction information, the charges including charges incurred in multiple, different currencies;
convert the charges incurred in the multiple, different currencies to a standard currency unit;
aggregate the charges in the standard currency to generate aggregate charge information in the standard currency unit;
compare the aggregate charge information to a threshold; and
upon determining that the aggregate charge information satisfies the threshold apply a discount to the charges for each of the accounts and the billing group in the multiple, different currencies.

8. The system of claim 7, wherein the billing group includes multiple logically connected accounts with each account having an associated currency.

9. The system of claim 7, wherein the configurations to convert the charges to the standard currency unit include configurations to convert the charges for each transaction to the standard currency unit.

10. The system of claim 7, wherein the configurations to convert the charges to the standard currency unit include configurations to:
sum the charges for each of the multiple different currencies to generate an aggregate charge for each of the multiple different currencies;
convert the aggregate charge for each of the multiple different currencies to the standard currency unit.

11. The system of claim 7, wherein the messages include information about a location where the charge was incurred and the method further comprises determining the base currency based on the location where the charge was incurred.

12. The system of claim 7, wherein the system is further configured to:
compare the aggregate charge information to a notification threshold;
upon determining that the aggregate charge information satisfies the notification threshold send a notification to the account owner associated with the account.
